(19) United States
(12) Patent Application Publication
(10) Pub. No.: US 2008/0282226 A1
(43) Pub. Date: Nov. 13, 2008

(54) METHODS AND APPARATUS FOR DISPLAYING A DYNAMICALLY UPDATED SET OF TEST DATA ITEMS DERIVED FROM VOLATILE OR NONVOLATILE STORAGE

(76) Inventors: Carli Connally, Fort Collins, CO (US); Bryan Carpenter, Loveland, CO (US)

Correspondence Address: Gregory W. Osterloth;Holland & Hart, LLP, P.O. Box 8749, Denver, CO, 80201, US

(21) Appl. No.: 11/745,389

(22) Filed: May 7, 2007

(51) Int. Cl. G06F 9/44

(52) U.S. Cl. 717/111; 717/168

(57) ABSTRACT

In one embodiment, a computer determines a plurality of data types associated with different ones of a plurality of test data items, and based on the determined data types, i) logs a first set of the plurality of test data items to volatile storage, and ii) logs a second set of the plurality of test data items to nonvolatile storage. The computer also monitors a current state of a graphical user interface (GUI). When the current state of the GUI is one of a first number of GUI states, the computer displays via the GUI, a dynamically updated set of test data items derived from the volatile storage. When the current state of the GUI is one of a second number of GUI states, the computer displays, via the GUI, a dynamically updated set of test data items derived from the nonvolatile storage. Other embodiments are also disclosed.

### BACKGROUND

When testing circuit devices such as system-on-a-chip (SOC) devices, tests may sometimes be executed in a production mode or a debug mode. The “production mode” is a mode in which numerous devices are tested, usually with the intent of distributing passing ones of the devices to end-users or customers. The “debug mode” is a mode in which 1) a small number of devices are submitted to testing for the purpose of debugging a test or test program, or 2) a small number of tests are executed for the purpose of debugging a problem identified in one or more devices.

In production mode, a user might want to acquire and view test data very quickly. In such a case: it is preferable to store the test data in memory. However, in debug mode, a user might want to capture a large amount of detailed test data, and the test data may not fit in memory. In this case, it may be necessary to store the test data on disk (e.g., in a database). A problem, however, is that most test applications are configured to either 1) store all test data in memory, or 2) store all test data on disk.

If a test application is configured to store all test data in memory, and the test data does not fit in memory, older data may need to be discarded to make way for newer data. On the other hand, if a test application is configured to store all test data on disk, a user may not be able to view test data as quickly as they would like.

In some cases, the above problem is resolved by developing two separate test applications—one for acquiring and viewing test data in production mode, and one for acquiring and viewing test data in debug mode. However, dual test applications do not use resources efficiently, and a user may be required to learn two different interface structures.

### BRIEF DESCRIPTION OF THE DRAWINGS

Illustrative embodiments of the invention are illustrated in the drawings, in which:

FIG. 1 illustrates an exemplary computer-implemented method for displaying a dynamically updated set of test data items retrieved from volatile or nonvolatile storage;

FIGS. 2-5 illustrate exemplary windows of a graphical user interface (GUI) that may be configured using the method shown in FIG. 1;

FIG. 6 illustrates an exemplary implementation of the user interface displayed by the method shown in FIG. 1;

FIG. 7 illustrates an exemplary test system in which the user interface shown in FIG. 6 may be incorporated;

FIG. 8 illustrates a first exemplary mode of the test system shown in FIG. 7;

FIG. 9 illustrates a second exemplary mode of the test system shown in FIG. 7 and

FIG. 10 illustrates an alternative embodiment of the user interface shown in FIG. 7.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

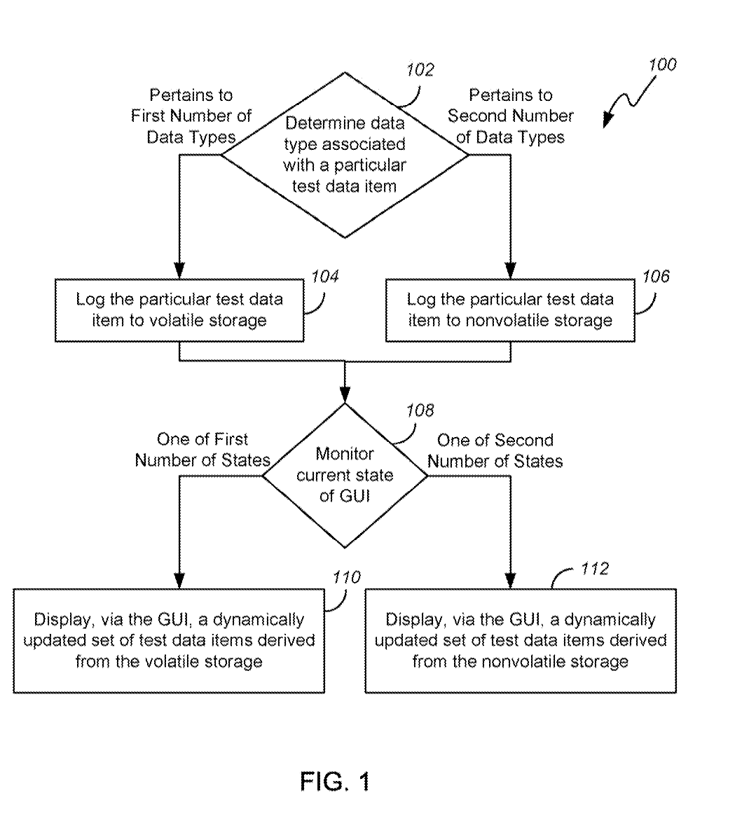

In accord with one embodiment of the invention, FIG. 1 illustrates a computer-implemented method 100. In block 102, the method 100 determines a plurality of data types associated with different ones of a plurality of test data items. Based on the determined data types, i) a first set of the plurality of test data items are logged to volatile storage based on the determined data types, i) logging a first set of the plurality of test data items to volatile storage, and ii) logging a second set of the plurality of test data items to nonvolatile storage (block 104), and ii) a second set of the plurality of test data items are logged to nonvolatile storage (block 106). In block 106, a current state of a graphical user interface (GUI) is monitored. When the current state of the GUI is one of a first number of GUI states, a dynamically updated set of test data items derived from the volatile storage is displayed via the GUI (block 110). When the current state of the GUI is one of a second number of GUI states, a dynamically updated set of test data items derived from the nonvolatile storage is displayed via the GUI (block 112). By way of example, the volatile storage may be a random access memory (RAM), and the nonvolatile storage may be a hard disk.

The test data items displayed by the method 100 may take various forms, and may comprise, for example: raw test data items, compiled or processed test data items, test context data items, test times, or test statistics. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In one embodiment, the test data items stored in the volatile or nonvolatile storage may be provided by one of the data formatters disclosed in the U.S. patent application of Connally, et al. entitled “Apparatus for Storing and Formatting Data” (Ser. No. 11/345,040).

In some embodiments of the method 100, the data types that cause ones of the plurality of test data items to be logged to volatile or nonvolatile storage are configurable. For example, the GUI may provide a dialog window that enables a user to select whether certain test results, test statistics or test execution times are logged to volatile or nonvolatile storage. In other embodiments of the method 100, the data types that cause test data items to be logged to volatile or nonvolatile storage are predetermined and not configurable.

In some cases, test data items may be individually associated with a data type, such that the method individually determines the data type of each test data item. In other cases, the test data items may be generated or received in a sequential order, such that the type of a particular test data item may be inferred by the test data item's location in the sequential order.

The method 100 can be useful in that it enables a common GUI to 1) quickly display smaller sets of test data obtained from volatile storage (e.g. display the test data in real time), and 2) store and retrieve larger sets of test data from nonvolatile storage. This can obviate the need to code and maintain two separate interfaces, maximize performance when possible, and provide storage for large data sets.

Of note, the steps of the method 100 may take orders other than that which is shown in FIG. 1. However, it is preferred that the steps be performed repetitively, and substantially in parallel.

The method 100 shown in FIG. 1 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer-readable code will typically comprise software, but could also comprise firmware or a programmed circuit.

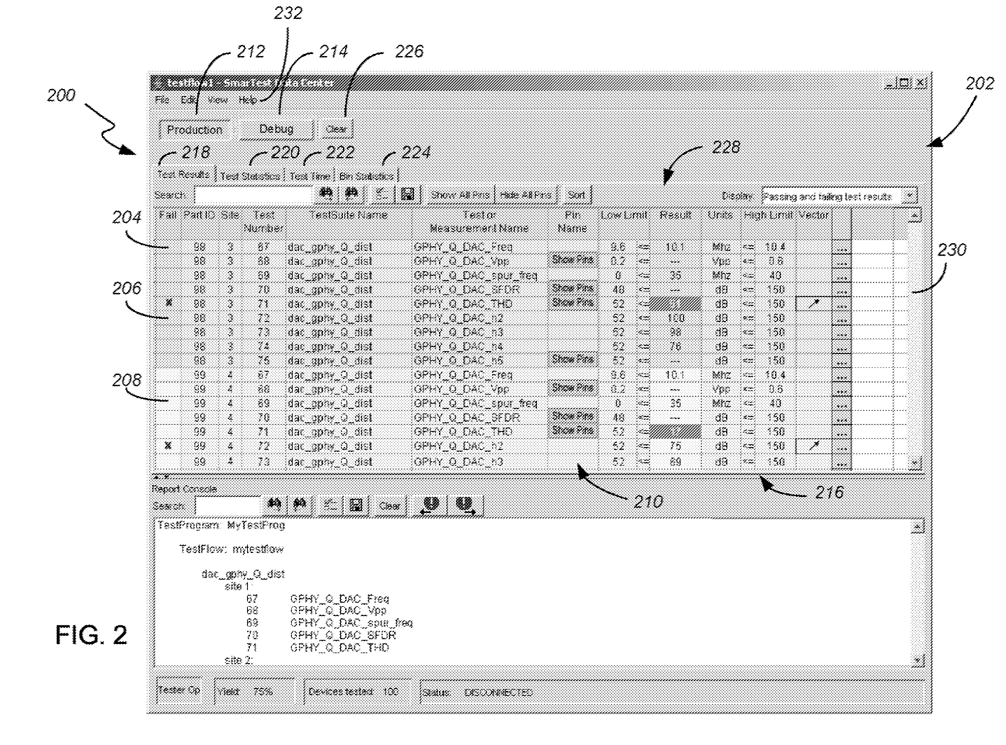

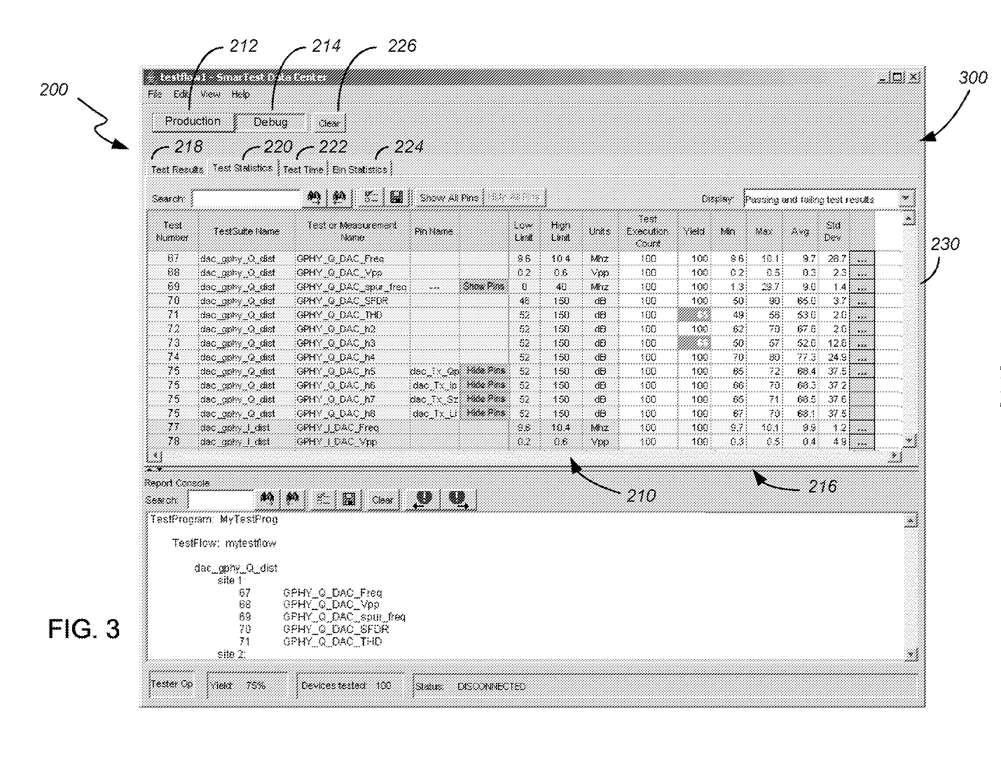

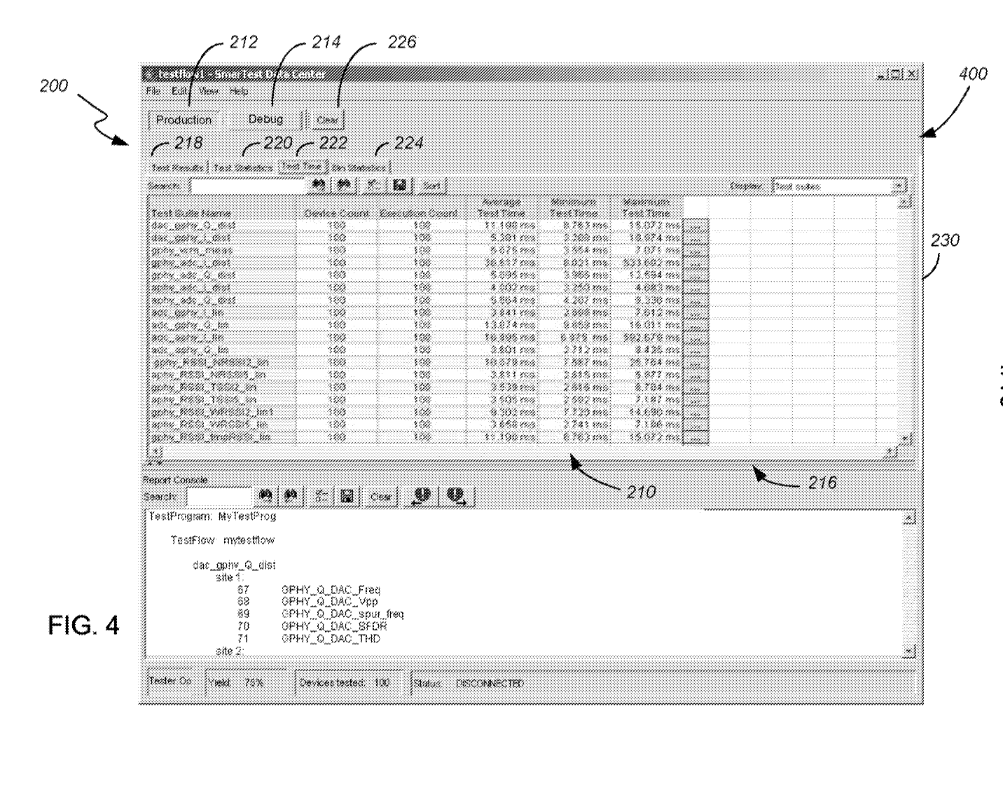

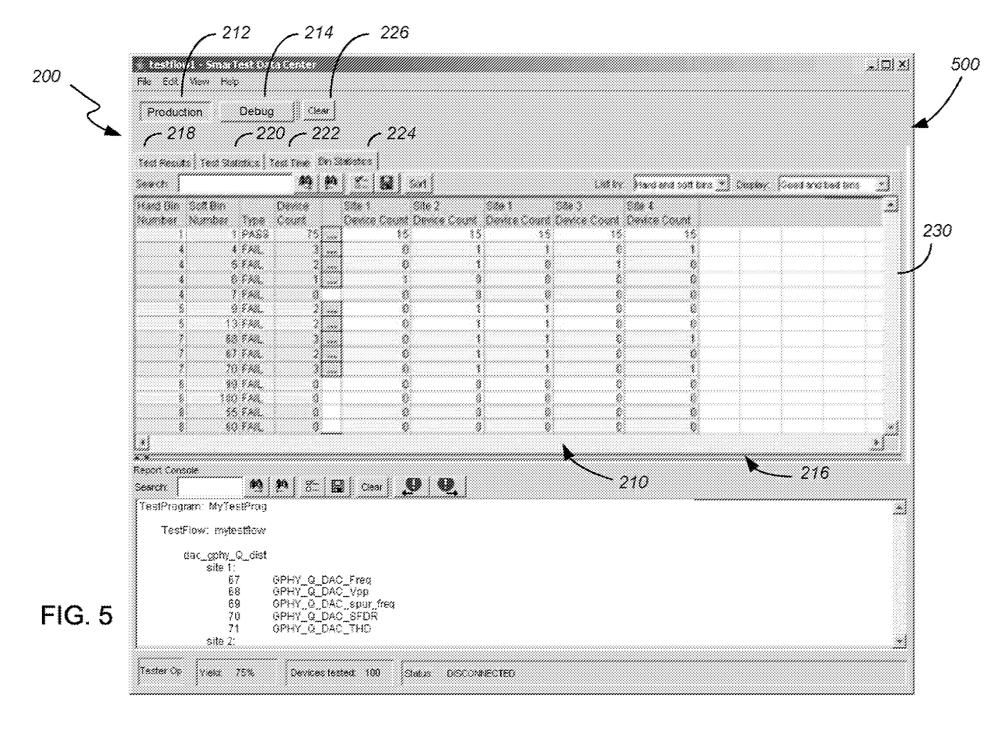

FIGS. 2-5 illustrate various exemplary states 202, 300, 400, 500 of a graphical user interface (GUI) 200 that may be configured via the method 100. In the GUI state 202 shown in FIG. 2, the dynamically updated test data items include individual test results. In the GUI state 300 shown in FIG. 3, the dynamically updated test data items include test statistics. In the GUI state 400 shown in FIG. 4, the dynamically updated test data items include test execution times. In the GUI state 500 shown in FIG. 5, the dynamically updated test data items include test results displayed in summary form by device bin. A “device bin” may include a “hard bin”, corresponding to a physical lot or container of devices under test, and a “soft bin”, corresponding to, for example, devices that have been submitted to a particular test or test suite.

The different GUI states 202, 300, 400, 500 shown in FIGS. 2-5 may be selected by means of graphical tabs 218, 220, 222, 224 labeled “Test Results”, “Test Statistics”, “Test Times” and “Bin Statistics”. Given that a user may desire to monitor test execution times and bin statistics during production test, and given that this data is relatively sparse compared to a data set containing individual test results or detailed test statistics, the test data items associated with the “Test Times” and “Bin Statistics” tabs 222, 224 may be stored in (and retrieved from) volatile storage. In this manner, they may be accessed more quickly during production test. However, given the large volume of data that may be needed to support the “Test Results” and “Test Statistics” tabs 218, 220, the test data items associated with these tabs may be stored in (and retrieved from) nonvolatile storage, such as a database stored on disk.

In one embodiment, the tabs 218, 220, 222, 224 are subservient to buttons 212, 214 or other means for selecting a “Production Mode” or a “Debug Mode”. In such an embodiment, the “Test Results” and “Test Statistics” tabs 218′ 220 may be grayed-out when in the “Production Mode”, so as to discourage a user from selecting these modes when access to data in a time-critical fashion is desired. However, the GUI 200 may provide a configuration option (e.g., via a pull-down menu from menu bar 232) via which a user may enable access to the “Test Results” and “Test Statistics” tabs 218, 220 during the “Production Mode”.

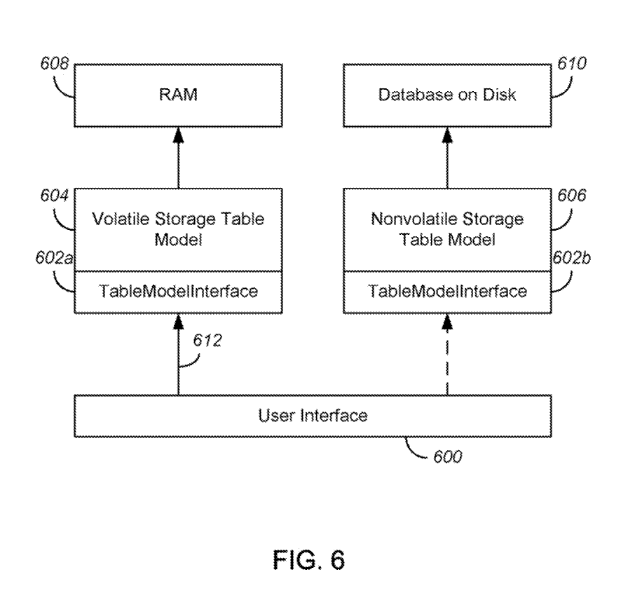

FIG. 6 illustrates a first exemplary implementation of the GUI displayed by the method 100. As shown, the GUI 600 contains a reference 612 to one of a number of table model objects 604, 606 that implement instances 602a, 602b of a common table model interface, such as the Java™ Swing™ TableModelInterface. In one embodiment, the object may be a Volatile Storage Table Model 604 that holds the dynamically updated set of test data items derived from the volatile storage, or a Nonvolatile Storage Table Model 606 that holds the dynamically updated set of test data items derived from the nonvolatile storage. The Volatile Storage Table Model 604 may access data from RAM 608, and the Nonvolatile Storage Table Model 606 may access data from a database 610 stored on disk. The GUI 600 operates the same, regardless of the table model 604, 606 that it references. Computer-readable code may dynamically switch the GUI's reference 612 to point to the table model 604 or the table model 606, depending on the current state of the GUI 600.

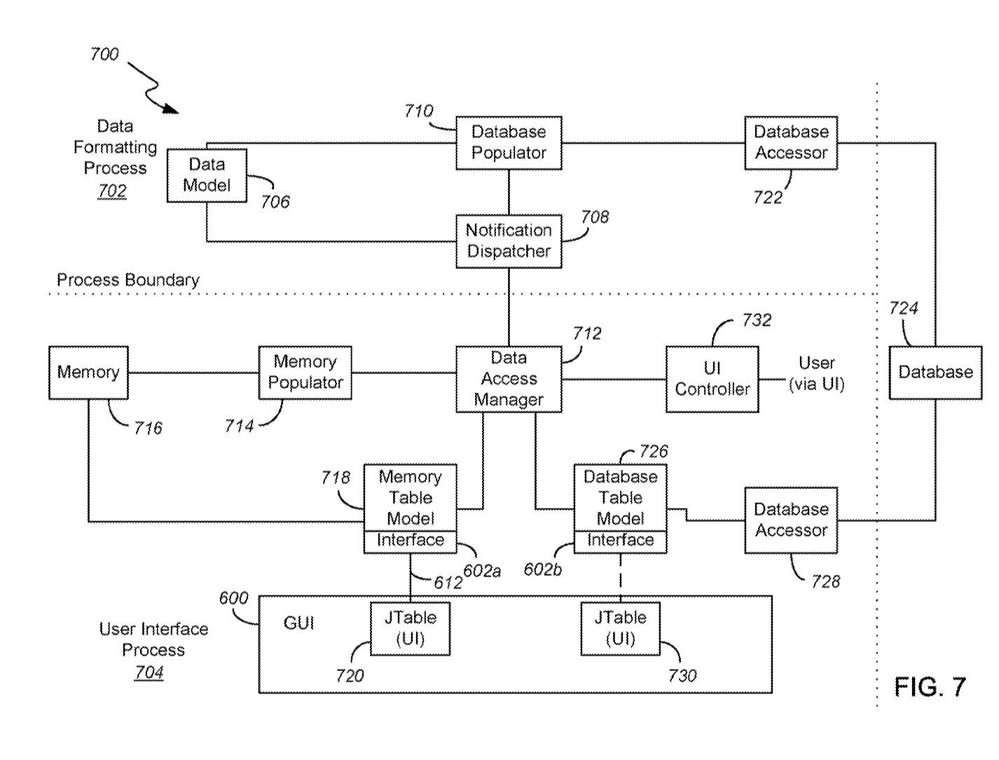

FIG. 7 illustrates an exemplary incorporation of the GUI 600 into a test system 700. The test system 700 has a data formatting process 702 and a user interface process 704, The data formatting process 702 receives test data that is generated during test of a device under test, and formats and saves the test data in a data model 706. A notification dispatcher 708 notifies a database populator 710 and/or data access manager 712 when new test data items become available in the data model 706. A user interface (UI) controller 732 provides a mechanism by which a user can, among other things, select the test application mode of the test system 700 (including the current state of the GUI 600).

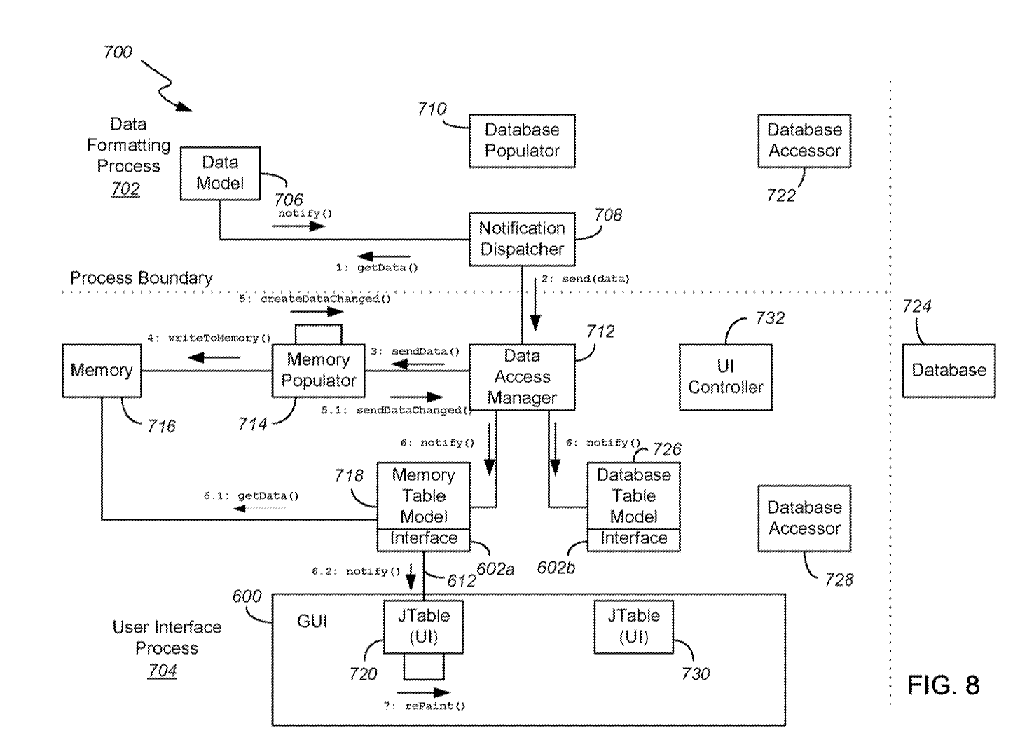

When a test data item having one of a first number of types is received by the test system 700, and as shown in FIG. 8, the notification dispatcher 708 retrieves the test data item from the data model 706 and sends the test data item to the data access manager 712 of the user interface process 704. The data access manager 712 then sends the test data item to a memory populator 714, which in turn writes the test data item to the memory 716 (i.e., volatile storage). Upon writing the test data item to the memory 716, the memory populator 714 notifies the data access manager 712. If the current state of the GUI 600 is one of a first number of states, the data access manager 712 notifies the memory table model 718 (i.e., a Volatile Storage Table Model). The table model 718 then compiles or updates its set of test data items, as necessary, and notifies a Java™ Swing™ JTable 720 of the GUI 600. Using its reference to the table model 718, the JTable 720 repaints (i.e., updates) the GUI 600.

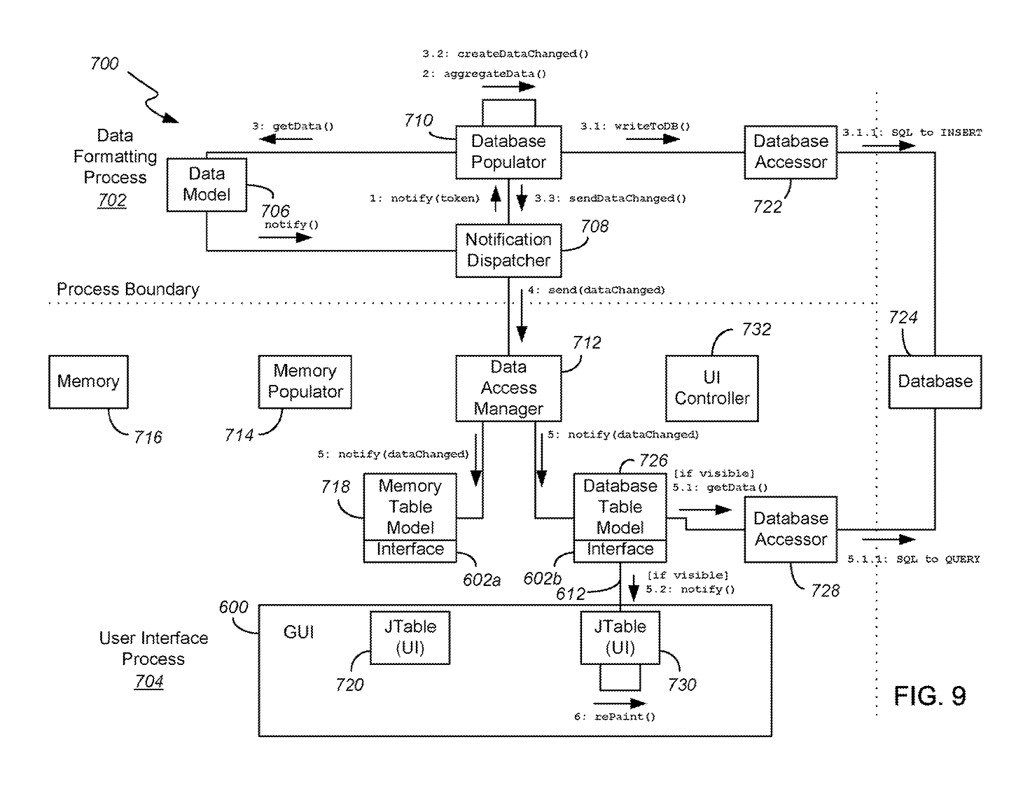

When a test data item having one of a second number of types is received by the test system 700, and as shown in FIG. 9, the notification dispatcher 708 notifies the database populator 710 that the test data item is available. The database populator 710 then retrieves the test data item from the data model 706 and writes it to a database 724 (i.e., nonvolatile storage) via a database accessor 722. Upon writing the test data item to the database 724, the database populator 710 notifies the notification dispatcher 708, which in turn notifies the data access manager 712. If the current state of the GUI 600 is one of a second number of states, the data access manager 712 then notifies the database table model 726 (i.e., a Nonvolatile Storage Table Model), and the table model 726 dynamically compiles or updates its set of test data items, as necessary, by accessing the test data item in the database 724 via a database accessor 728. The table model 726 subsequently notifies a Java™ Swing™ JTable 730 of the GUI 600. Using its reference to the table model 726, the JTable 730 repaints (i.e., updates) the GUI 600.

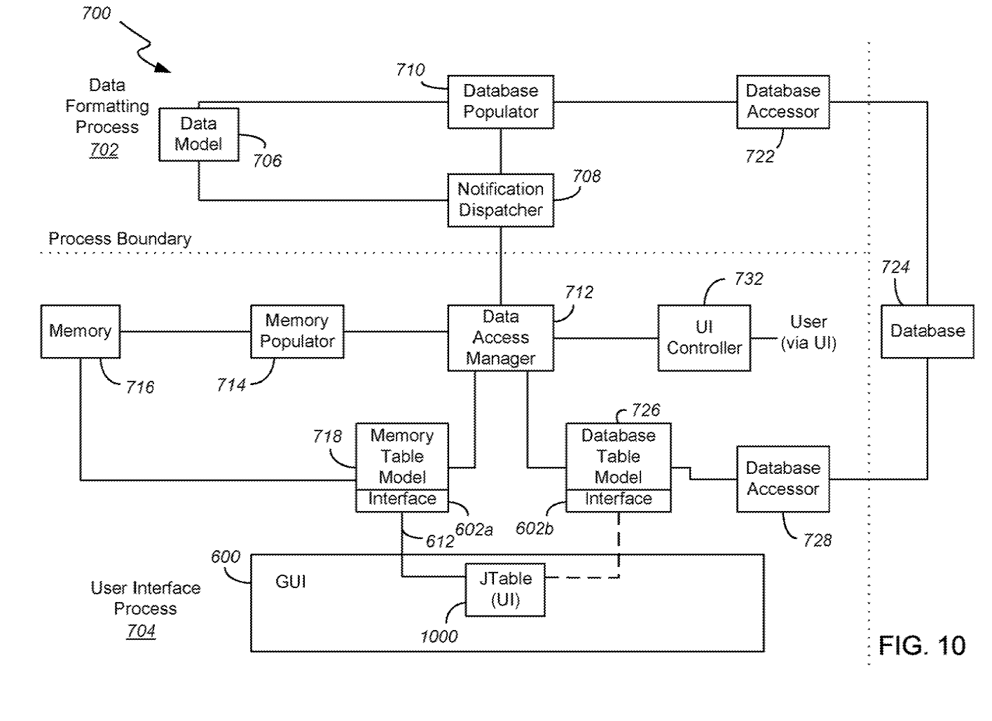

In the test system 700, and by way of example, computer-readable code switches the user interface's reference 612 to point to the table model 718 or the table model 726 by respectively and dynamically configuring the GUI 600 to incorporate 1) a first table object (e.g., a first Java™ Swing™ JTable 720) that accesses the interface 602a of the table model 606, or 2) a second table object (e.g. JTable 730) that accesses the interface 602b of the table model 726. Alternately, and as shown in FIG. 10, computer-readable code could switch the user interface's reference 612 by dynamically configuring a single table object 1000 to access 1) the interface 602a of the table model 718, or 2) the interface 602b of the table model 726.

As previously mentioned, FIGS. 2-5 illustrate exemplary states 202, 300, 400, 500 of a user interface 200 that may be configured via the method 100. By way of example, the window 202 displays a plurality of test data entries 204, 206 and 208, each of which includes a plurality of test data items. By way of example, each test data entry 204, 206, 208 includes three test result identifiers, including: a “Test Number”, a “Test or Measurement Name”, and a “TestSuite Name” that identifies a test suite to which the test name and number belong. In addition, each test data entry 204, 206, 208 comprises information identifying the test resources via which a test result was acquired (e.g., a test “Site” number), and information identifying the device and pin for which a test result was acquired (e.g., a device “Part ID”, and a device “Pin Name”). Each test data entry 204, 206, 208 also comprises one or more test results, which may take forms such as a value in a “Result” field and/or a check in a “Fail” field (e.g., for those tests that have failed). For measurement-type test results, “Unit”, “Low Limit” and “High Limit” fields may also be populated.

Preferably, the window 202 is displayed during execution of a plurality of tests on which the test data entries 204, 206, 208 are based (i.e., during test of a device under test). New test results can then be displayed via the window as they are acquired, and a user can be provided a “real-time” display of test results. Alternately, device testing can be completed, and a log of test results can be saved to volatile or nonvolatile storage (e.g., memory or a hard disk). The test results can then be read and displayed in succession via the window 202 (i.e., not in real-time). Typically, the test data entries 204, 206, 208 that are displayed at any one time represent only some of the test data entries or items that are generated during execution of a plurality of tests. One or more mechanisms such as a scroll bar 230 may be provided to allow a user to navigate to different test data entries or items.

By way of example. FIG. 2 illustrates a display of test data 228 in a production mode (i.e., a state in which the test data entries 204, 206, 208 pertain to production test data). A graphical button 212 labeled “Production” is associated with the production mode and serves as both a production mode identifier and production mode selector. Similarly, a graphical button 214 labeled “Debug” is associated with a display of test data in a debug mode and serves as both a debug mode identifier and selector. In one embodiment of the GUI 200, the buttons 212, 214 are displayed via the window 202 at all times.

As a result of FIG. 2 illustrating a display of production test data 228, the “Production” button 212 is shown depressed, and the “Debug” button 214 is shown un-depressed. If a user graphically clicks on the “Debug” button 214, the GUI 200 may be updated to show the “Debug” button 214 depressed and the “Production” button 212 un-depressed. In addition, the GUI 200 may be updated to focus on a display of debug test data. When the GUI 200 is updated, the test data entries 204, 206, 208 shown in the common fill area 216 may be replaced with test data entries pertaining to a debug mode. Alternately, the production display and debug display could comprise respective and different windows of the GUI 200, and an update of the GUI 200 to focus on the production display or the debug display could result in a pertinent one of the windows being launched and/or brought to the front of the GUI (i.e., overlaid over the other window).

Although the “Production” and “Debug” buttons 212, 214 are shown in FIG. 2 to serve as both mode identifiers and mode selectors, their identifying and selecting functions could alternately be provided via separate sets of buttons. Or, the buttons 212, 214 could be replaced or supplemented by other mechanisms, such as: graphical tabs, check boxes, pull-down menu selections, pop-up menu selections, graphical toolbar icons, or dialog box options. The buttons 212, 214 could also take the form of a single mechanism, such as a button, that is dynamically reconfigured to allow a user to select whichever mode is not currently selected (i.e., production or debug).

Also, in addition to (or instead of) one of the buttons 212, 214 being shown depressed to indicate which of the production display or debug display is currently displayed, the buttons 212, 214 or other identification/selection mechanisms could be distinguished in other ways, such as by use of contrasting colors, highlighting or bolded text labels.

In addition to providing graphical buttons 212, 214 for selecting the production mode or the debug mode, the GUI 200 provides a plurality of graphical tabs 218, 220, 222, 224 labeled “Test Results”, “Test Statistics”, “Test Time” and “Bin Statistics”. These tabs 218, 220, 222, 224 are subservient to the mode selector buttons 212, 214, such that selection of one of the mode selector buttons 212, 214 results in the tabs 218, 220, 222, 224 being alternately configured to access production test data or debug test data. Similarly, test data items pertaining to 1) the production mode or the debug mode, and 2) one of the tabs 218, 220, 222 or 224, are swapped into the common fill area 216. Thus, for example, selection of the “Test Statistics” tab 220 while the “Debug” button 212 is depressed would result in test statistics pertaining to the debug mode being displayed in the common fill area 216, as shown in FIG. 3. That is, test statistics based solely on debug data would be displayed in the common fill area 216.

As further shown in FIG. 2, each of the test data entries 204, 206, 208 may be displayed as a line of a table 210, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

Similarly to the mode selector buttons 212, 214, the tabs 218, 220, 222 and 224 could also be implemented in other ways. For example, the tabs 218, 220, 222 and 224 could be implemented via any or all of: graphical buttons, check boxes, pull-down menu selections, pop-up menu selections, graphical toolbar icons, or dialog box options.

FIGS. 4 & 5 illustrate exemplary states of the GUI 200 after selection of the “Test Time” or “Bin Statistics” tabs 222, 224. The general content of these displays has already been discussed.

What is claimed is:

1. Apparatus, comprising:
computer-readable media;
computer-readable code, stored on the computer-readable media including,
code to determine a plurality of data types associated with different ones of a plurality of test data items, and based on the determined data types, i) log a first set of the plurality of test data items to volatile storage, and ii) log a second set of the plurality of test data items to nonvolatile storage;
code to monitor a current state of a graphical user interface (GUI), and i) when the current state of the GUI is one of a first number of GUI states, display, via the GUI, a dynamically updated set of test data items derived from the volatile storage, and ii) when the current state of the GUI is one of a second number of GUI states, display, via the GUI, a dynamically updated set of test data items derived from the nonvolatile storage.

2. The apparatus of claim 1, wherein the volatile storage is a random access memory.

3. The apparatus of claim 1, wherein the nonvolatile storage is a hard disk.

4. The apparatus of claim 1, further comprising code to, in response to user input to the GUI, configure the data types that cause ones of the plurality of test data items to be logged to the volatile storage or the nonvolatile storage.

5. The apparatus of claim 1, wherein the first number of GUI states comprises a state in which test results are displayed in summary form by device bin, and wherein the second number of GUI states comprises a state in which individual test results are displayed.

6. The apparatus of claim 1, wherein the first number of GUI states comprises a state in which test execution times are displayed.

7. The apparatus of claim 1, wherein the dynamically updated set of test data items derived from the volatile storage and the dynamically updated set of test data items derived from the nonvolatile storage are respectively compiled as first and second table models and wherein each of the first and second table models implements an instance of a common table model interface.

8. The apparatus of claim 1, further comprising code to dynamically configure the GUI to display the dynamically updated set of test data items derived from the volatile storage, or the dynamically updated set of test data items derived from the nonvolatile storage, by respectively and dynamically configuring the GUI to incorporate i) a first table object that accesses an interface of a table model holding the dynamically updated set of test data items derived from the volatile storage, or ii) a second table object that accesses an interface of a table model holding the dynamically updated set of test data items derived from the nonvolatile storage.

9. The apparatus of claim 1, further comprising code to dynamically configure the GUI to display the dynamically updated set of test data items derived from the volatile storage, or the dynamically updated set of test data items derived from the nonvolatile storage, by respectively and dynamically configuring a table object of the GUI to access i) an interface of table model holding the dynamically updated set of test data items derived from the volatile storage, or ii) an interface of a table model holding the dynamically updated set of test data items derived from the nonvolatile storage.

10. The apparatus of claim 1, further comprising code to display at least one mechanism for selecting the current state of the GUI.

11. A computer-implemented method, comprising:
determining a plurality of data types associated with different ones of a plurality of test data items;
based on the determined data types, i) logging a first set of the plurality of test data items to volatile storage, and ii) logging a second set of the plurality of test data items to nonvolatile storage;
monitoring a current state of a graphical user interface (GUI);
when the current state of the GUI is one of a first number of GUI states, displaying via the GUI, a dynamically updated set of test data items derived from the volatile storage; and
when the current state of the GUI is one of a second number of GUI states, displaying via the GUI, a dynamically updated set of test data items derived from the nonvolatile storage.

12. The method of claim 11, wherein the volatile storage is a random access memory.

13. The method of claim 11, wherein the nonvolatile storage is a hard disk.

14. The method of claim 11, further comprising in response to user input to the GUI configuring the data types that cause ones of the plurality of test data items to be togged to the volatile storage or the nonvolatile storage.

15. The method of claim 11, wherein the first number of GUI states comprises a state in which test results are displayed in summary form by device bin, and wherein the second number of GUI states comprises a state in which individual test results are displayed.

16. The method of claim 11, wherein the first number of GUI states comprises a state in which test execution times are displayed.

17. The method of claim 11, further comprising:
respectively compiling the dynamically updated set of test data items derived from the volatile storage, and the dynamically updated set of test data items derived from the nonvolatile storage, as first and second table models, wherein each of the first and second table models implements an instance of a common table model interface.

18. The method of claim 11, further comprising:
dynamically configuring the GUI to display the dynamically updated set of test data items derived from the volatile storage, or the dynamically updated set of test data items derived from the nonvolatile storage, by respectively and dynamically configuring the GUI to incorporate i) a first table object that accesses an interface of a table model holding the dynamically updated set of test data items derived from the volatile storage, or ii) a second table object that accesses an interface of a table model holding the dynamically updated set of test data items derived from the nonvolatile storage.

19. The method of claim 11, further comprising:
dynamically configuring the GUI to display the dynamically updated set of test data items derived from the volatile storage, or the dynamically updated set of test data items derived from the nonvolatile storage, by respectively and dynamically configuring a table object of the GUI to access i) an interface of table model holding the dynamically updated set of test data items derived from the volatile storage, or ii) an interface of a table model holding the dynamically updated set of test data items derived from the nonvolatile storage.

20. The method of claim 11, further comprising, displaying at least one mechanism for selecting the current state of the GUI.
